(19) United States
(12) Patent Application Publication
(10) Pub. No.: US 2025/0199734 A1
(43) Pub. Date: Jun. 19, 2025

(54) IMAGE FORMING SYSTEM

(71) Applicant: Toshiba Tec Kabushiki Kaisha, Tokyo (JP)

(72) Inventors: Kouichirou NISHI, Sunto Shizuoka (JP); Sou MIYAZAKI, Sunto Shizuoka (JP); Yusuke HAMADA, Mishima Shizuoka (JP); Yutaka KUKITSU, Odawara Kanagawa (JP)

(21) Appl. No.: 18/666,249

(22) Filed: May 16, 2024

(30) Foreign Application Priority Data
Dec. 15, 2023 (JP) 2023-212107

(51) Int. Cl. G06F 3/12; H04N 1/00

(52) U.S. Cl. CPC G06F 3/1257; G06F 3/1238; H04N 1/00244

(57) ABSTRACT

According to an embodiment, an image forming system includes: a server; and an image forming apparatus. The server generates an illustration using an illustration generation condition specified by a user in a device that performs communication via a network. The image forming apparatus acquires the illustration generated using the illustration generation condition from the server. The image forming apparatus prints the illustration acquired from the server on a medium.

### CROSS-REFERENCE TO RELATED APPLICATIONS

This application is based upon and claims the benefit of priority from the prior Japanese Patent Application No. 2023-212107, filed on Dec. 15, 2023, the entire contents of which are incorporated herein by reference.

### FIELD

An embodiment to be described here generally relates to an image forming system.

### BACKGROUND

Some image forming apparatuses such as digital multifunction devices have a function of printing an image on not only regular paper but also a plurality of types of special media (special media). In the past, there has been a system that provides a service for printing images such as illustrations prepared in advance on special media using an image forming apparatus. In such a system, the image forming apparatus prints the image selected by a user from predetermined images prepared in advance without copyright issues on the special medium. That is, the existing system has a problem that the image to be printed on the special medium by the image forming apparatus is limited to those selected from predetermined images prepared in advance.

### BRIEF DESCRIPTION OF THE DRAWINGS

FIG. 1 is a cross-sectional view showing an example of an image forming system according to an embodiment.

FIG. 2 is a block diagram showing an example of a server in the image forming system according to the embodiment.

FIG. 3 is a cross-sectional view showing an example of a multi-functional peripheral (MFP) that is an image forming apparatus according to the embodiment.

FIG. 4 is a block diagram showing an example of a control system in the MFP that is an image forming apparatus according to the embodiment.

FIG. 5 is a diagram schematically showing model creation processing for creating an illustration generation model for each illustrator by the server in the image forming system according to the embodiment.

FIG. 6 is a sequence for describing the model creation processing for creating an illustration generation model for each illustrator by the server in the image forming system according to the embodiment.

FIG. 7 is a diagram schematically showing illustration generation processing for generating an illustration according to a user's request by the server in the image forming system according to the embodiment.

FIG. 8 is a sequence for describing the illustration generation processing for generating an illustration according to a user's request by the server in the image forming system according to the embodiment.

FIG. 9 is a diagram schematically showing illustration printing processing for printing the illustration generated by the server in the image forming system according to the embodiment on a medium by the MFP.

FIG. 10 is a sequence for describing the illustration printing processing for printing the illustration generated by the server in the image forming system according to the embodiment on a medium by the MFP.

### DETAILED DESCRIPTION

According to an embodiment, an image forming system includes: a server; and an image forming apparatus. The server includes a first communication interface and a processor. The first communication interface performs communication via a network. The processor is configured to generate an illustration using an illustration generation condition specified by a user in a device that performs communication via the network by the first communication interface. The image forming apparatus includes a second communication interface, a controller, and a printer. The second communication interface communicates with the server. The controller is configured to acquire the illustration generated by the second communication interface using the illustration generation condition from the server. The printer prints the illustration acquired from the server on a medium.

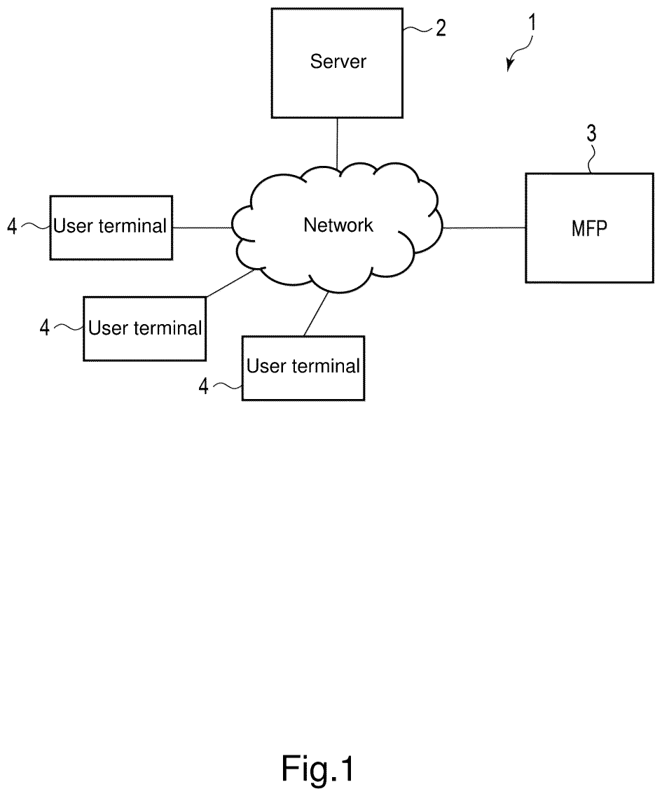

This embodiment will be described below with reference to the drawings. In the drawings, the same reference symbols denote the same or similar portions. An image forming system 1 according to an embodiment will be schematically described. FIG. 1 is a block diagram schematically showing a configuration example of the image forming system 1 according to the embodiment. As shown in FIG. 1, the image forming system 1 includes a server 2, a multi-functional peripheral (MFP, a digital multifunction device) 3, user terminals 4, and the like. In the image forming system 1, the server 2 is connected to the MFP 3 and the user terminals 4 via a network.

The server 2 is an apparatus that provides an illustration as an image to be printed. The server 2 is a platform (content platform) that provides, as one piece of content, an illustration to be printed. However, in this embodiment, the illustration is not limited to illustrations used for commercial purposes and may include paintings and the like. That is, the illustration in this embodiment refers to a broadly defined picture created by a specific author (illustrator).

The server 2 communicates with the MFP 3 and the user terminals 4 via the network. The server 2 manages information for each account. The server 2 generates an illustration in accordance with a request from a user who has logged in with a specific account (using an illustration generation condition). The server 2 generates an illustration that reflects the personality of a specific illustrator specified by a user using an illustration generation condition specified by the user.

For example, the server 2 acquires illustrations for learning provided from an illustrator who has given consent (consent to provide illustrations to a third party) in advance. The illustrations for learning only need to be those from which characteristics of pictures created by the illustrator can be detected and may include paintings and the like. The server 2 generates an illustration generation model (program for generating illustrations) for each illustrator by performing machine learning using a group of illustrations for learning for each illustrator.

The server 2 is capable of generating an illustration that reflects the personality of each illustrator by generating an illustration using an illustration generation model for each illustrator. The server 2 creates an illustration generation model for each illustrator and holds the created illustration generation model for each illustrator. The server 2 generates an illustration according to an illustration generation condition specified by a user (a user's request) using an illustration generation model of an illustrator specified by the user. The server 2 stores, in a storage device, the illustration generated in accordance with a user's request using the illustration generation model of an illustrator specified by the user and provides the stored illustration in accordance with a user's request.

The MFP 3 is an image forming apparatus that forms an image on a medium (media). The MFP 3 has a function of forming an image on not only paper but also various special media. The MFP 3 communicates with the server 2 and acquires an image such as an illustration from the server 2. For example, the MFP 3 acquires the illustration generated in accordance with a user's request from the server 2 and prints the illustration acquired from the server 2 on a special medium specified by the user.

The user terminal 4 is a terminal apparatus to be operated by a user. The user terminal 4 only needs to be an information processing apparatus that communicates with the server 2 via a network. For example, the user terminal 4 may be a personal computer (PC) or a mobile terminal such as a smartphone and a tablet PC.

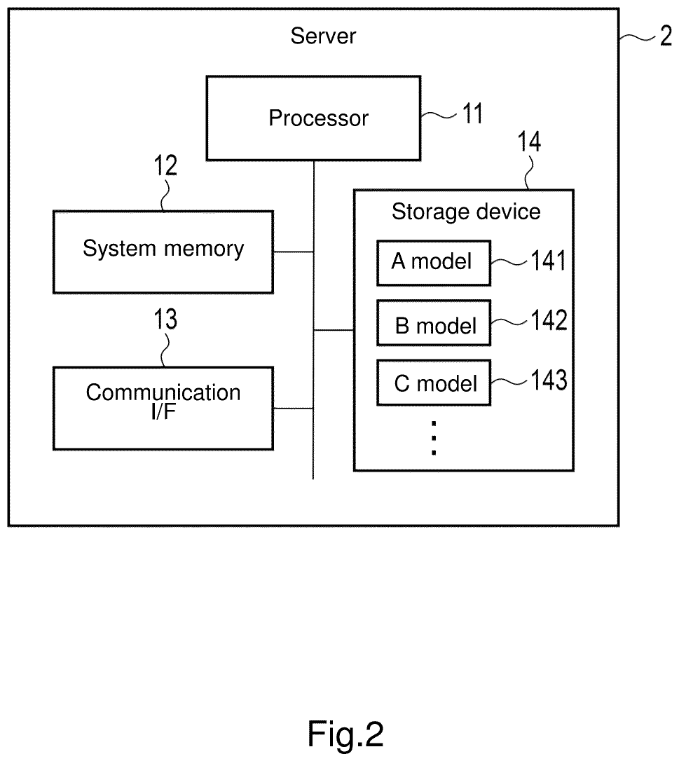

Next, the configuration of the server 2 in the image forming system 1 according to the embodiment will be described. FIG. 2 is a block diagram schematically showing a configuration example of the server 2 in the image forming system 1 according to the embodiment. As shown in FIG. 2, the server 2 includes a processor 11, a system memory 12, a communication interface (I/F) 13, a storage device 14, and the like.

The processor 11 executes a program to execute various types of processing. The processor 11 includes, for example, a central processing unit (CPU). The processor 11 executes the program stored in the system memory 12 or the storage device 14 to execute various types of processing described below.

The system memory 12 includes a memory such as a random access memory (RAM), a read only memory (ROM), and a non-volatile memory (NVM). The RAM functions as a working memory or a buffer memory. The ROM is a non-rewritable non-volatile memory. The ROM functions as a program memory. The NVM is a rewritable non-volatile memory. The NVM stores a program, setting data, and the like.

The communication I/F 13 is an interface for performing data communication with an external device. The communication I/F 13 includes an interface for communicating with the MFP 3 and the user terminal 4 via a network. The communication I/F 13 may include an interface for wireless communication or an interface for wired communication.

The storage device 14 includes a rewritable non-volatile memory. For example, the storage device 14 includes a storage device such as a hard disk drive (HDD) and a solid-state drive (SSD). The storage device 14 stores various types of setting information, image data such as illustrations, and data such as various programs. For example, the storage device 14 is a memory that stores user information. The storage device 14 is also a storage device that stores image data as an illustration generated using a condition specified by a user.

The storage device 14 of the server 2 according to the embodiment stores an illustration generation model created for each illustrator, which will be described below. In FIG. 2, an A model 141, a B model 142, and a C model 143 are exemplified as illustration generation models for each illustrator. Assumption is made that the A model 141 is an illustration generation model of an illustrator A created by model creation processing described below. Assumption is made that the B model 142 is an illustration generation model of an illustrator B and the C model 143 is an illustration generation model of an illustrator C.

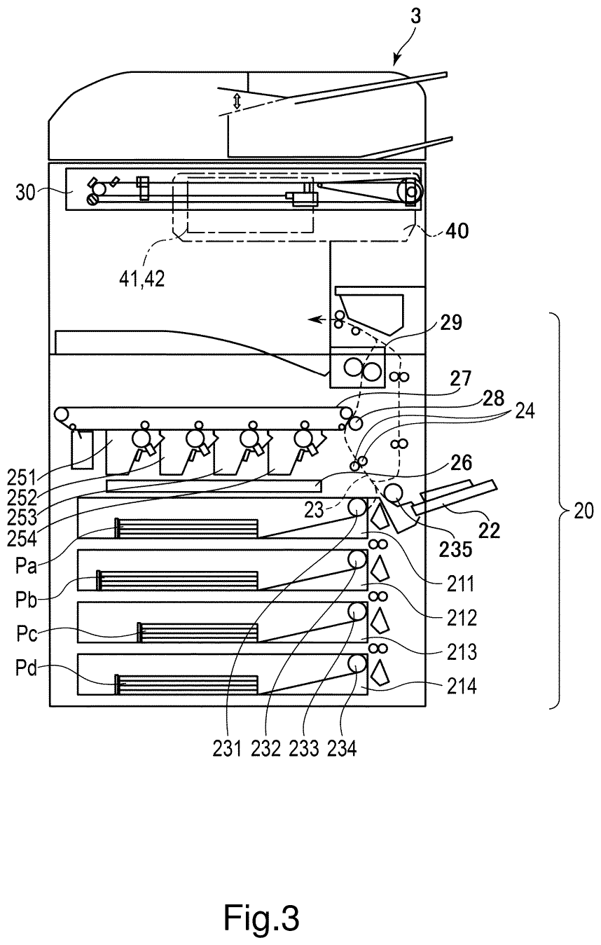

Next, the configuration of the MFP 3 that is an image forming apparatus in the image forming system 1 according to the embodiment will be described. FIG. 3 is a cross-sectional view schematically showing a configuration example of the MFP 3 that is an image forming apparatus in the image forming system 1 according to the embodiment. As shown in FIG. 3, the MFP 3 includes a printer 20, a scanner 30, an operation panel 40, and the like.

The scanner 30 is installed in the upper part of the body of the MFP 3. The scanner 30 is a device that optically reads an image of a manuscript. The scanner 30 includes manuscript table glass for placing a manuscript to be scanned. The scanner 30 has an image reading mechanism for scanning the manuscript on the manuscript table glass. The image reading mechanism of the scanner 30 includes a carriage installed below the manuscript table glass, a photoelectric conversion unit, and the like. The scanner 30 may include auto document feeder (ADF).

The printer 20 includes paper feed cassettes 211, 212, 213, and 214. Each of the paper feed cassettes 211, 212, 213, and 214 houses a medium such as paper on which an image is to be formed. Each of the paper feed cassettes 211, 212, 213, and 214 is a supply portion that supplies the set medium to the printer 20. The medium to be housed in the paper feed cassettes 211, 212, 213, and 214 only needs to be a medium that can be conveyed by a conveying system described below. For example, each of the paper feed cassettes 211, 212, 213, and 214 is attachable/detachable to/from the lower part of the body of the digital multifunction device.

The printer 20 further includes a bypass tray 22. A medium such as paper on which an image is to be formed is placed on the bypass tray 22. The bypass tray 22 is a supply portion that supplies the set medium to the printer 20. The medium to be set in the bypass tray 22 only needs to be a medium that can be conveyed by a conveying system described below.

The paper feed cassettes 211, 212, 213, and 214 respectively include paper feed rollers 231, 232, 233, and 234. The paper feed rollers 231, 232, 233, and 234 respectively take out the medium one by one from the paper feed cassettes 211, 212, 213, and 214. The bypass tray 22 includes a paper feed roller 235. The paper feed roller 235 takes out the medium set in the bypass tray 22 one by one.

Various medium Pa, Pb, Pc, and Pd on which an image can be printed by the printer 20 are respectively set in the paper feed cassettes 211, 212, 213, and 214 as the supply portions. A medium on which an image can be printed by the printer 20 is set in the bypass tray 22 as the supply portion. The type of medium that can be set in each of the paper feed cassettes 211, 212, 213, and 214 and the bypass tray 22 is determined in advance. For example, some media cannot be housed in the paper feed cassettes 211 to 214 but can be set in the bypass tray 22.

A conveying system (conveying mechanism) 23 conveys a medium (hereinafter, referred to as paper) in the printer 20. The conveying system 23 includes a plurality of conveying roller and the like. The conveying system 23 conveys paper taken out by the paper feed rollers 231, 232, 233, 234, and 235 using conveying rollers provided at various locations on the conveying path. Conveying rollers constituting the conveying system 23 include a resist roller 24. The resist roller 24 is provided in front of an image transfer position at which an image is transferred to paper on the conveying path. The resist roller 24 supplies paper to the image transfer position at the timing of transferring an image.

An image forming device 25 includes a plurality of image forming devices 251, 252, 253, and 254. The plurality of image forming devices 251, 252, 253, and 254 forms an image using a toner set therein. For example, the image forming devices 251, 252, 253, and 254 form an image using toners of yellow, magenta, cyan, and black, respectively.

An exposure device 26 forms an electrostatic latent image as an image to be developed in each color on an image carrier in each of the image forming devices 251, 252, 253, and 254. The exposure device 26 forms an electrostatic latent image on the image carrier by scanning the image carrier with light emitted in accordance with image data. For example, the exposure device 26 applies light emitted by a light-emitting unit to a photoreceptor drum that is an image carrier via a rotating polygon mirror to perform the scanning in a main scanning direction. The irradiation position of light from the exposure device 26 moves in a sub-scanning direction due to the rotation of the photoreceptor drum. The position and magnification of the image to be formed by the image forming device 25 are adjusted by controlling the exposure device 26. The image forming devices 251, 252, 253, and 254 develop the electrostatic latent images on the image carriers with toners of the respective colors (yellow, magenta, cyan, and black). An intermediate transfer belt 27 is an intermediate transfer body. The image forming device 25 transfers (primarily transfers) the toner images of the respective colors developed on the image carriers with the respective colors onto the intermediate transfer belt 27.

The intermediate transfer belt 27 holds the transferred toner image and sends it to a secondary transfer position (image transfer position to paper). The secondary transfer position is a position at which the toner image on the intermediate transfer belt 27 is transferred to paper. The secondary transfer position is a position at which one support roller that supports the intermediate transfer belt 27 and a secondary transfer roller 28 face each other. The secondary transfer roller 28 and the support roller that faces the secondary transfer roller 28 constitute a transfer device. The resist roller 24 conveys paper to the secondary transfer position at the correct timing for the toner image on the intermediate transfer belt 27. The transfer device that includes the secondary transfer roller 28 and the support roller transfers the toner image held on the intermediate transfer belt 27 to the paper at the secondary transfer position (image transfer position).

For example, in the case of forming a color image, the image forming devices 251, 252, 253, and 254 superimpose the toner images developed with the toners of the respective colors (yellow, magenta, cyan, and black) on each other and transfer the obtained color image onto the intermediate transfer belt 27. The intermediate transfer belt 27 holds the color image in which the toner images of the respective colors are superimposed on each other. The transfer device 28 transfers the color image on the intermediate transfer belt 27, which is obtained by the toners of a plurality of colors, to the paper at the secondary transfer position. The resist roller 24 conveys paper to the secondary transfer position at the correct timing for the toner image on the intermediate transfer belt 27. As a result, a color image is transferred to the paper.

The transfer device that includes the secondary transfer roller 28 and the support roller supplies, a fixing device 29, the paper onto which the toner image has been transferred. The fixing device 29 fixes the toner image to the paper. The fixing device 29 includes a heating unit, a heat roller, a pressure roller, and the like. The heating unit heats the heat roller. The heat roller and the pressure roller perform fixing processing of heating the paper onto which the toner image has been transferred by the transfer device in a pressurized state. The paper subjected to the fixing processing by the heat roller and the pressure roller in the fixing device 29 is conveyed to a paper ejection tray or a duplex unit via a conveying roller.

The paper ejection tray is a table on which a medium that has been subjected to printing processing including image transfer and fixing processing is discharged. The duplex unit resupplies a medium having a first surface (front surface) on which an image has been formed, in a state where an image can be formed on a second surface (back surface). For example, the duplex unit switches back the medium that has been subjected to fixing processing using a roller or the like to turn the medium upside down and resupplies the medium to the resist roller 24.

The operation panel 40 is a user interface. The operation panel 40 displays guidance and accepts input to an operation button. For example, a user inputs setting information on the operation panel 40. The operation panel 40 includes a display device 41 and an operation device (input device) 42. For example, the display device 41 and the operation device 42 include a display device equipped with a touch panel. The touch panel as the operation device 42 is provided on the display screen of the display device as the display device 41. The touch panel as the operation device 42 detects the area touched by the user on the display screen of the display device 41.

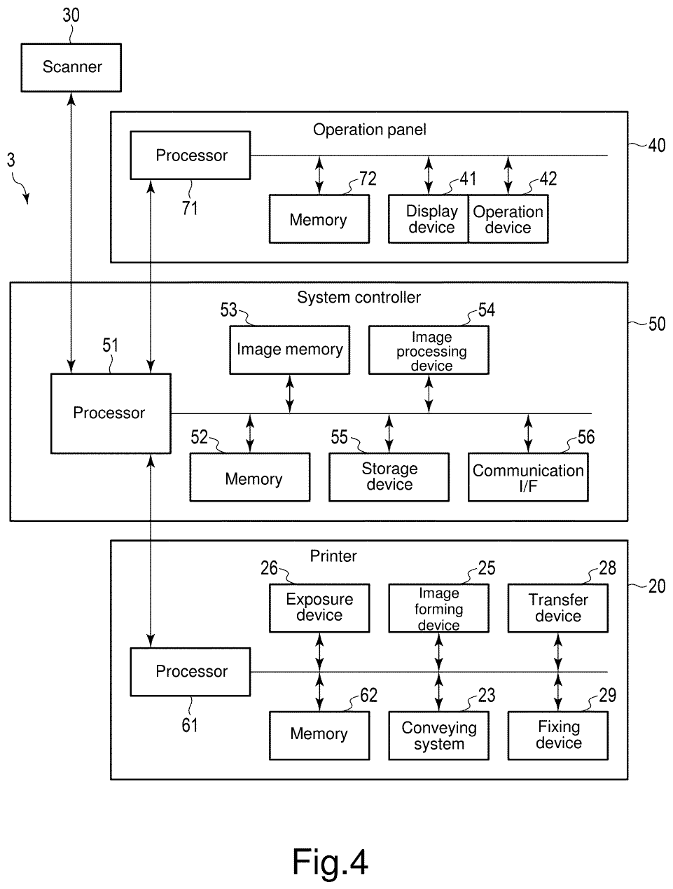

Next, the configuration of a control system in the MFP 3 configured as described above will be described. FIG. 4 is a block diagram for describing a configuration example of a control system in the MFP 3 according to the embodiment. The MFP 3 includes a system controller (controller) 50 that controls the entire apparatus. The system controller 50 is connected to the scanner 30, the printer 20, and the operation panel 40. In the configuration example shown in FIG. 4, the system controller 50 includes a processor 51, a memory 52, an image memory 53, an image processing device 54, a storage device 55, a communication interface (I/F) 56, and the like.

The processor 51 controls the respective units in the system controller 50 and performs various types of data processing. The processor 51 realizes various processing functions by executing the program stored in the memory 52 or the storage device 55. For example, the processor 51 execute the program stored in the memory 52 to output operation instructions to the respective units and process various type of information from the respective units. The processor 51 is connected to the scanner 30, a processor 61 of the printer 20, and a processor 71 of the operation panel 40 via an interface or the like.

The memory 52 includes a memory such as a random access memory (RAM), a read only memory (ROM), and a non-volatile memory (NVM). The RAM functions as a working memory or a buffer memory. The ROM is a non-rewritable non-volatile memory. The ROM functions as a program memory. The NVM is a rewritable non-volatile memory. The NVM stores setting data and the like. The image memory 53 stores image data. For example, the image memory 53 functions as a page memory for developing image data to be processed.

The image processing device 54 processes image data. For example, the image processing device 54 performs image processing such as correction, compression, and expansion on the input image data and outputs the obtained image data. For example, the image processing device 54 may include a processor for image processing. The image processing device 54 may perform image processing on an image to be printed in accordance with the properties of a medium such as a special medium on which an image is to be printed.

The storage device 55 stores data such as control data, a control program, and setting information. The storage device 55 includes a rewritable non-volatile memory. For example, the storage device 55 includes a storage device such as a hard disk drive (HDD) and a solid-state drive (SSD).

The communication I/F 56 is an interface for performing data communication with an external device. The communication I/F 56 includes an interface for communicating with the server 2 via a network. The communication I/F 56 may include an interface for communication connection to the user terminal 4. The communication I/F 56 may include an interface for communicating with an external device in a local area network.

Next, a configuration example of a control system in the printer 20 will be described. As shown in FIG. 4, the printer 20 includes the processor 61, a memory 62, the conveying system 23, the image forming device 25, the exposure device 26, the transfer device 28, and the fixing device 29, and the like. The processor 61 executes the program stored in the memory 62 to realize various types of processing. For example, the processor 61 executes the program to control the operations of the respective units in the printer 20 and monitor the operating status of the respective units. The processor 61 is connected to the processor 51 of the system controller 50 via an interface. The processor 61 executes print processing and the like in accordance with an operation instruction from the system controller 50.

The memory 62 includes a memory such as a random access memory (RAM), a read only memory (ROM), and a data memory. The RAM functions as a working memory or a buffer memory. The ROM is a non-rewritable non-volatile memory. The ROM functions as a program memory. The data memory is a rewritable non-volatile memory.

The conveying system 23 conveys paper in the printer 20 under the control of the processor 61. The conveying system 23 drives the paper feed rollers 231, 232, 233, 234, and 235 provided in the paper feed cassettes 21 (211, 212, 213, and 214) or the bypass tray 22 in which paper selected by a user is housed, in accordance with an operation instruction from the processor 61. The conveying system 23 drives the corresponding conveying roller to convey the paper picked up by the specific paper feed roller 231, 232, 233, 234, or 235.

The exposure device 26 applies light (laser beam) for forming an electrostatic latent image on the respective photoreceptor drums of the image forming device 25, in accordance with an operation instruction from the processor 61. The processor 61 controls the irradiation position of the laser beam to the photoreceptor drum by the exposure device 26 to adjust the print position, magnification, and the like. The processor 61 executes image adjustment using a print reference described below as a starting point by operation control in accordance with the print range such that a desired print range is achieved.

The image forming device 25 (251, 252, 253, and 254) develops the electrostatic latent images formed on the photoreceptor drums with the toners of the respective colors, in accordance with an operation instruction from the processor 61. The image forming device 25 transfers (primarily transfers) the toner images formed on the photoreceptor drums onto the intermediate transfer belt 27.

The transfer roller as the transfer device 28 transfers (secondarily transfers) the toner image that has been transferred onto the intermediate transfer belt 27 to paper, in accordance with an operation instruction from the processor 61. The fixing device 29 drives the heat roller and the pressure roller in accordance with an operation instruction from the processor 61. The heating unit of the fixing device 29 adjusts the surface temperature of the heat roller to a desired fixing temperature under the control of the processor 61. The fixing device 29 fixes the toner image that has been transferred to paper to the paper while the surface temperature is controlled to the fixing temperature.

Next, a configuration example of a control system in the operation panel 40 will be described. As shown in FIG. 4, the operation panel 40 includes the processor 71, a memory 72, the display device 41, the operation device (input device) 42, and the like. The processor 71 executes the program stored in the memory 72 to realize various types of processing. For example, the processor 71 executes the program to control the operations of the respective units in the operation panel 40 and monitor the operating status of the respective units. The processor 71 is connected to the processor 51 of the system controller 50 via an interface. For example, the processor 71 notifies the system controller 50 of information input by a user.

The memory 72 includes a memory such as a random access memory (RAM), a read only memory (ROM), and a data memory. The RAM functions as a working memory or a buffer memory. The ROM is a non-rewritable non-volatile memory. The ROM functions as a program memory. The data memory is a rewritable non-volatile memory.

In the display device 41, the display content is controlled in accordance with an operation instruction from the processor 71. The touch panel as the operation device 42 is provided on the display screen of the display device 41 and detects a touched position on the display screen. For example, the processor 71 displays, on the display screen of the display device 41, operation guidance and an icon that can be selected on the operation device (touch panel) 42. The processor 71 identifies the information input by a user in accordance with the touched position detected by the touch panel as the operation device 42. An operation button such as a hard key including a start key and a reset key may be provided on the operation panel 40.

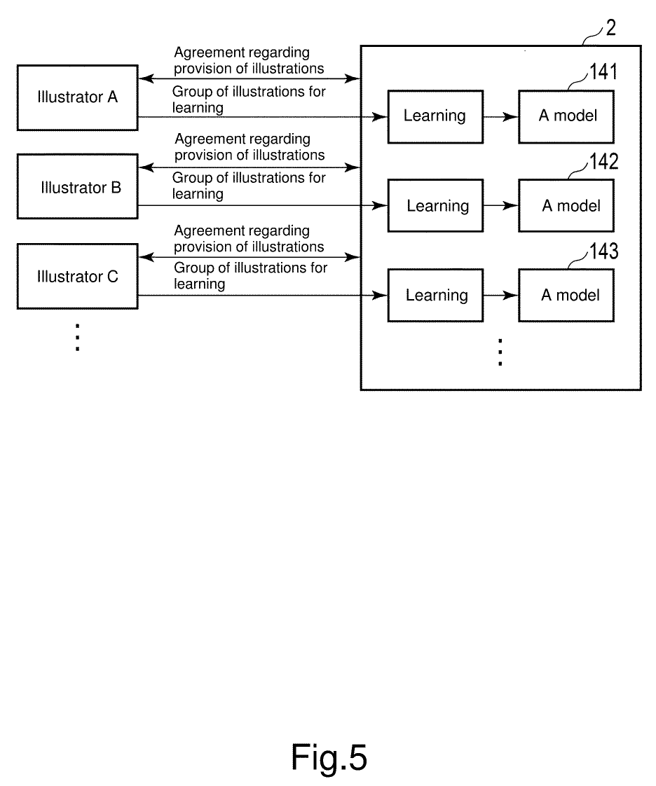

Next, model creation processing for creating an illustration generation model for each illustrator by the server 2 in the image forming system 1 according to the embodiment will be described. FIG. 5 is a diagram schematically showing the model creation processing for creating an illustration generation model for each illustrator by the server 2 in the image forming system 1 according to the embodiment. Assumption is made that the server 2 carries out a service for providing an illustration automatically generated in accordance with a user's request to a user (illustration providing service). A service provider that provides an illustration using the server 2 enters into an agreement with individual illustrators regarding provision of illustrations. The illustrator agrees with a service provider to provide an automatically-generated illustration that reflects the characteristics of illustrations created by himself/herself to a third party (user).

The server 2 acquires a group of illustrations for learning from an illustrator who has given consent (agreement regarding provision of illustrations) in advance. In the example shown in FIG. 5, the server 2 acquires a group of illustrations for learning provided from the illustrator A who has entered into an agreement regarding provision of illustrations. The server 2 creates the A model 141 as an illustration generation model (generative AI model) by machine learning using the group of illustrations acquired from the illustrator A. The server 2 stores the created A model 141 in the storage device 14.

The A model 141 is an AI that automatically generates an illustration that reflects the characteristics of illustrations created by the illustrator A (group of illustrations for learning). The A model 141 as an illustration generation model generates an illustration that reflects the characteristics of illustrations created by the illustrator A, in accordance with various specified illustration generation conditions (a situation, a background, a character, a medium for printing, and the like). In other words, the A model 141 is a program that creates an illustration with characteristics that look like it were created by the illustrator A, in accordance with a user's request.

A service provider that operates the server 2 enters into an agreement with the illustrator B and the illustrator C to provide illustrations, similarly. The server 2 creates the B model 142 and the C model 143 as illustration generation models by machine learning using a group of illustrations for learning provided from the illustrators B and C. In this way, the server 2 stores the A model 141, the B model 142, and the C model 143 as illustration generation models for each of the individual illustrators A, B, and C in the storage device 14.

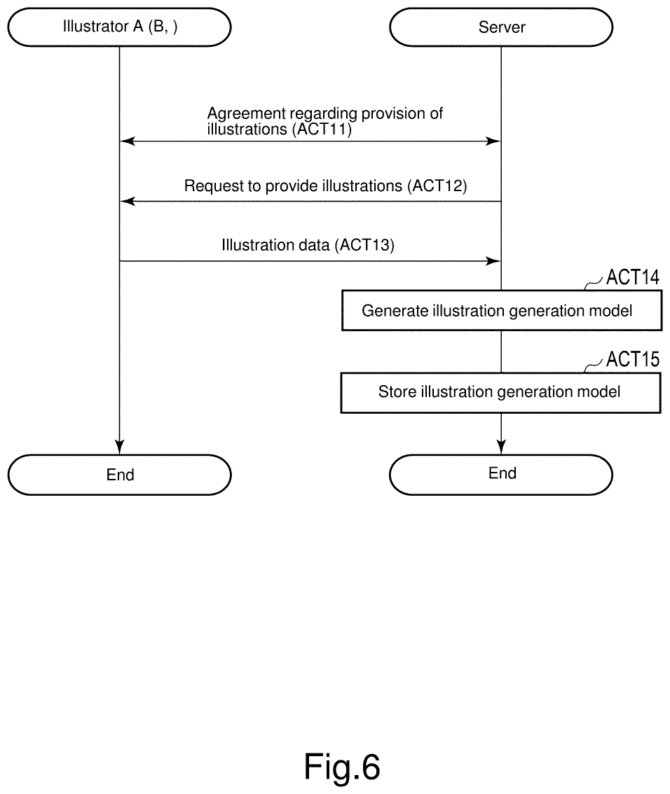

Next, a flow of the model creation processing for creating an illustration generation model for each illustrator by the server 2 in the image forming system 1 according to the embodiment will be described. FIG. 6 is a sequence for describing the model creation processing for creating an illustration generation model for each illustrator by the server 2 in the image forming system 1 according to the embodiment. First, the service provider that operates the server 2 enters into an agreement with individual illustrators regarding provision of illustrations (ACT11). The processor 11 of the server 2 requests an illustrator who has entered into an agreement regarding to provide a group of illustrations for learning (ACT12). For example, the processor 11 of the server 2 transmits a request for provision of a plurality of illustrations necessary for creating the illustration generation model for the illustrator to the contact address of the illustrator.

The illustrator requested to provide illustrations supplies data of a group of illustrations for learning (illustration data) to the server 2 using an information processing apparatus (or a storage medium) that can be connected to the server 2. The processor 11 of the server 2 acquires illustration data provided from the illustrator (ACT13).

For example, the illustrator inputs illustration data to the information processing apparatus connected to the server 2 via a network and transmits the illustration data from the information processing apparatus to the server 2. In this case, the server 2 acquires, by the communication interface 13, the illustration data from the information processing apparatus operated by the illustrator. The illustrator may provide a storage medium or a portable storage device storing the illustration data, which can be read by the server 2. In this case, the server 2 only needs to have a configuration to read the illustration data from the storage medium or the portable storage device provided from the illustrator.

The processor 11 of the server 2 creates, upon acquiring the illustration data as a group of illustrations for learning, an illustration generation model (generative AI model) by machine learning using the group of illustrations for learning (ACT14). The illustration generation model is an AI program that generates an illustration in the illustrator's style in accordance with the input illustration generation condition. The processor 11 of the server 2 stores, in the storage device 14, the created illustration generation model in association with illustrator information (ACT15).

The processor 11 of the server 2 executes the above-mentioned model creation processing for the individual illustrators who have entered into an agreement regarding provision of illustrations. In this way, the storage device 14 of the server 2 stores the illustration generation models of the respective illustrators. Note that the server 2 may update the illustration generation model of each illustrator as appropriate. For example, in the case of updating an illustration generation model, the processor 11 requests the corresponding illustrator to provide an additional group of illustrations for learning. The processor 11 only needs to update the illustration generation model for the illustrator by machine learning using the additional group of illustrations for learning acquired from the illustrator.

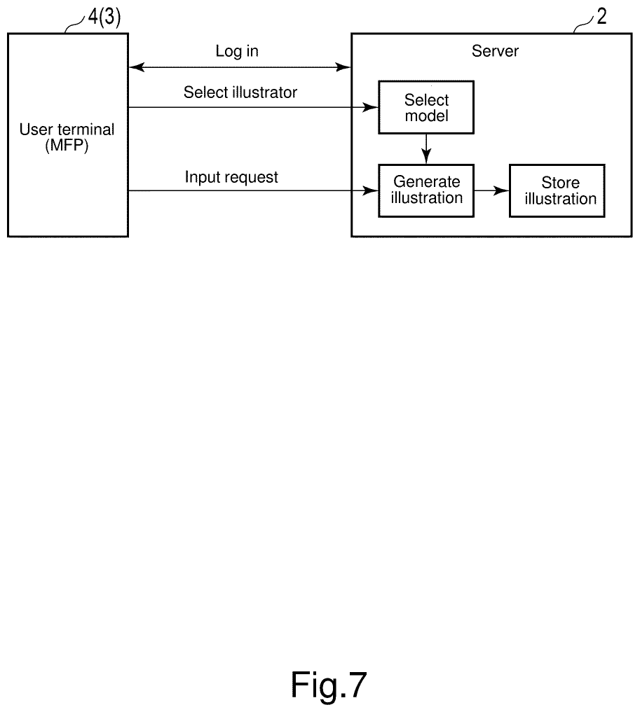

Next, illustration generation processing for generating an illustration using an illustration generation model by the server 2 in the image forming system 1 according to the embodiment will be described. FIG. 7 is a diagram schematically showing the illustration generation processing for generating an illustration using an illustration generation model by the server 2 in the image forming system 1 according to the embodiment. First, a user performs user (account) registration in order to receive an illustration providing service. For example, the user performs connection to the server 2 using the user terminal 4 and registers user information for the illustration providing service. The server 2 stores, in the storage device 14, user information (e.g., authentication information such as a user ID and a password) of the user registered by a predetermined procedure. The user whose user information has been registered by the server 2 can receive the illustration providing service.

The user who has completed user registration inputs user information using the user terminal 4 to receive the illustration providing service. The user terminal 4 transmits, to the server 2, a login request to the illustration providing service by the user information input by the user. The server 2 performs user authentication using the user information received together with the login request from the user terminal 4. When the user authentication succeeds, the server 2 makes the user terminal be in a logged-in state.

Note that the user may log in the server 2 not from the user terminal 4 but from the MFP 3 to receive the illustration providing service. In this case, the processing of the user terminal 4 described below may be one executed by the MFP 3. However, the illustration generation processing will be described assuming that the user logs in the server 2 using the user terminal 4.

The user terminal 4 logs in the server 2 (illustration providing service) and accepts selection of an illustrator and a user's request. For example, the user terminal 4 acquires information regarding a list of selectable illustrators from the server 2 in order to cause the user to select an illustrator. The user terminal 4 accepts selection of an illustrator from the list of selectable illustrators acquired from the server 2. The user terminal 4 transmits, when the user selects (specifies) an illustrator whose illustration is desired to be generated, information indicating the selected illustrator to the server 2.

The server 2 selects, upon receiving information indicating an illustrator from the user terminal 4, an illustration generation model for generating an illustration that reflects the characteristics of the selected illustrator. The server 2 accepts, when selecting an illustration generation model, a user's request to be used as an illustration generation condition for generating an illustration. As the user's request to be used as an illustration generation condition, a situation, a background, a character, a special medium for printing, or the like can be input.

The user terminal 4 accepts input of a user's request to be used as an illustration generation condition. For example, the user terminal 4 displays an input screen or the like for inputting a user's request on the display and accepts input of a request. The user terminal 4 transmits, when the user inputs a request for an illustration desired to be generated (illustration generation condition), information indicating the input user's request to the server 2. Note that the user terminal 4 may input an illustration generation condition (user's request) together with information regarding an illustrator.

The server 2 sets, upon receiving information indicating a user's request from the user terminal 4, the illustration generation condition according to the user's request to the illustration generation model for the selected illustrator. The server 2 generates an illustration by the illustration generation model for which the illustration generation condition according to the user's request has been set. The server 2 stores, in the storage device 14, the illustration generated using the illustration generation model in association with the user information of the user. As a result, the server 2 is capable of providing the illustration generated in accordance with the user's request, which is stored in the storage device 14, in accordance with a user's request.

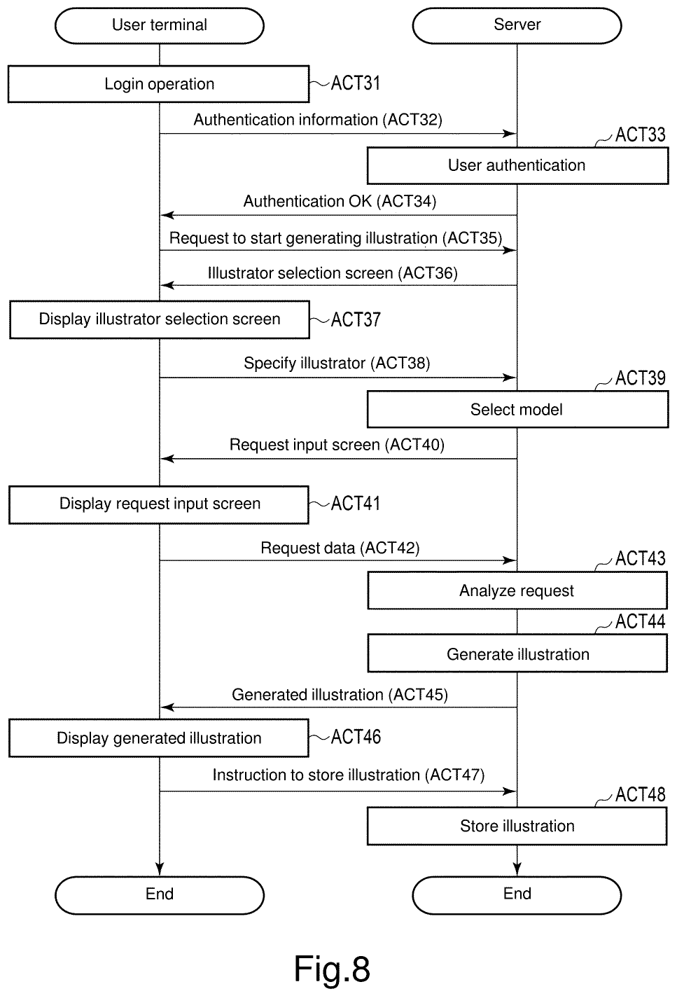

Next, illustration generation processing for generating an illustration using an illustration generation model by the server 2 in the image forming system 1 according to the embodiment will be described. FIG. 8 is a sequence for describing the illustration generation processing for generating an illustration by the server 2 in the image forming system 1 according to the embodiment.

First, a user performs a login operation to an illustration providing service using the user terminal 4 (or the MFP 3). Assumption is made that the user logs in the server 2 from the user terminal 4. The user terminal 4 (or the MFP 3) is connected to the server 2 and accepts input of user information (authentication information) by a user as a login operation to the illustration providing service (ACT31). The user terminal 4 transmits, to the server 2, user information including authentication information input by the user together with the login request to the illustration providing service (ACT32).

The server 2 receives the login request to the illustration providing service from the user terminal 4 by the communication interface 13. The processor 11 of the server 2 executes user authentication using the user information that includes the authentication information received together with the login request (ACT33). The processor 11 of the server 2 makes, when the user authentication succeeds, the user terminal be in a logged-in state, and transmits notification indicating authentication successful (authentication OK) to the user terminal 4.

Upon receiving the notification indicating authentication successful, the user terminal 4 notifies login completion and notifies that generation of an illustration by the server 2 (illustration providing service) has become possible. After logging in the server 2, the user terminal 4 requests the server 2 to start generating an illustration in accordance with a user's operation (ACT35).

The server 2 receives the request to start generating an illustration by the illustration providing service from the user terminal 4 by the communication interface 13. The processor 11 of the server 2 transmits, upon receiving the request to start generating an illustration, information indicating selectable illustrators to the user terminal 4 (ACT36). For example, the server 2 transmits, to the user terminal 4, information indicating a list of illustrators for whom illustration generation models have been created, as information indicating selectable illustrators. Assumption is made that the processor 11 of the server 2 transmits, to the user terminal 4, an illustrator selection screen for causing a specific illustrator to be selected from the selectable illustrators.

The user terminal 4 displays the illustrator selection screen on the display on the basis of the information acquired from the server 2 (ACT37). The user terminal 4 accepts selection of a specific illustrator while displaying the illustrator selection screen. The user terminal 4 transmits, when an illustrator whose illustration is desired to be generated is selected (specified), information indicating the selected illustrator to the server 2.

The server 2 receives the information indicating the specified illustrator from the user terminal 4 by the communication interface 13 (ACT38). The processor 11 of the server 2 selects, upon receiving the information indicating the specified illustrator, the illustration generation model of the specified illustrator (ACT39). The processor 11 of the server 2 accepts, upon selecting the illustration generation model, a user's request to be used as an illustration generation condition for generating an illustration (ACT40). Assumption is made that the processor 11 of the server 2 transmits, to the user terminal 4, a request input screen for accepting a user's request regarding an illustration to be generated.

The user terminal 4 displays, upon receiving a request input screen from the server 2, the request input screen for inputting a user's request received from the server 2 on the display (ACT41). The user terminal 4 accepts input of a user's request to be used as an illustration generation condition while displaying the request input screen. For example, a user inputs a situation, a background, a character, a medium for printing, and the like to the user terminal 4 as a request to be used as an illustration generation condition. The user terminal 4 transmits, when a user's request is input, the input user's request to the server 2 (ACT42).

The server 2 receives the user's request input in the user terminal 4 by the communication interface 13 (ACT42). The processor 11 of the server 2 specifies, upon receiving the user's request, an illustration generation condition to be set to the selected illustration generation model by analyzing the user's request (ACT43). The processor 11 of the server 2 sets the illustration generation condition specified from the user's request to the illustration generation model of the selected illustrator.

The processor 11 of the server 2 generates an illustration using the illustration generation model for which the illustration generation condition according to the user's request has been set (ACT44). The processor 11 of the server 2 transmits, to the user terminal 4, the illustration generated using the illustration generation model to cause the user to check the illustration (ACT45). Assumption is made that the processor 11 of the server 2 transmits, to the user terminal 4, an illustration checking screen that displays the generated illustration to cause the user to check the generated illustration.

The user terminal 4 receives, after transmitting the user's request, the illustration checking screen that includes the illustration generated by the server 2. The user terminal 4 displays the illustration checking screen received from the server 2 on the display (ACT46). The user terminal 4 accepts, while displaying the illustration checking screen, input of whether or not the displayed illustration is to be stored. The user terminal 4 transmits, when an instruction to store the illustration is made, an instruction to store the generated illustration to the server 2 (ACT47).

The server 2 receives the instruction to store the illustration input in the user terminal 4 by the communication interface 13 (ACT47). The processor 11 of the server 2 stores, upon receiving the instruction to store the illustration, the displayed illustration in the storage device 14 in association with information indicating the logged-in user (ACT45).

Through the illustration generation processing described above, the server according to the embodiment is capable of generating an illustration according to a user's request using an illustration generation model of an illustrator specified by a user. The server according to the embodiment is capable of storing an illustration generated in accordance with a user's request in a storage device and providing the stored illustration in accordance with a user's request.

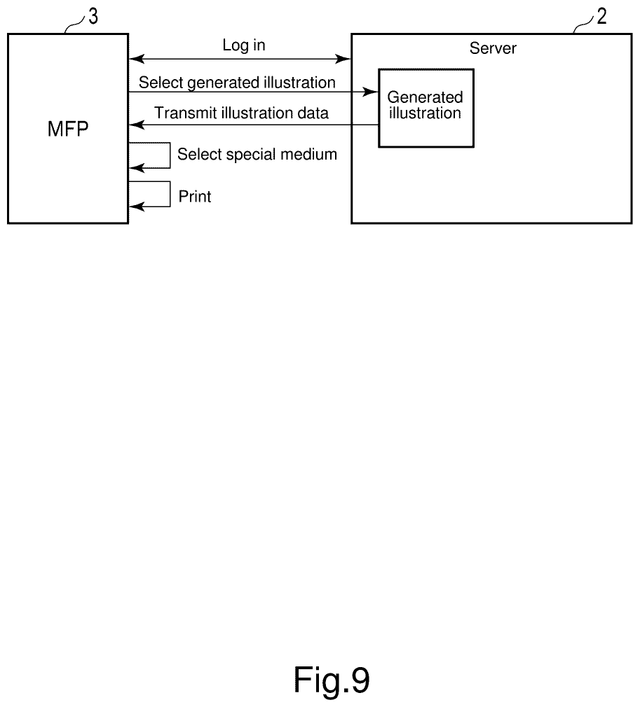

Next, illustration printing processing of printing an illustration generated by the server 2 in the image forming system 1 according to the embodiment on a special medium by the MFP 3 will be described. FIG. 9 is a diagram schematically showing the illustration printing processing of printing an illustration generated by the server 2 in the image forming system 1 according to the embodiment on a special medium by the MFP 3. Assumption is made that a user prints an illustration generated through the above-mentioned illustration generation processing on a special medium by the MFP 3. The user inputs user information for logging in the server 2 (illustration providing service) by the operation device 42 of the operation panel 40 of the MFP 3. For example, the system controller 50 of the MFP 3 transmits, to the server 2, a login request to the illustration providing service based on the user information input by the operation device 42. The server 2 performs user authentication using the user information received together with the login request from the MFP 3. The server 2 makes, when the user authentication succeeds, the user in a logged-in state in the MFP 3.

The MFP 3 logs in the server 2 (illustration providing service) and accepts selection of an illustration to be printed on a special medium from illustrations that have been generated in accordance with a request from the user. For example, the MFP 3 acquires information of illustrations that have been generated and stored by the user from the server 2 in order to cause the user to select an illustration to be printed. The MFP 3 accepts selection of an illustration to be printed from a list of selectable illustrations acquired from the server 2. The MFP 3 transmits, when the user selects (specifies) an illustration to be printed, information indicating the selected illustration to the server 2.

The server 2 downloads, upon receiving information indicating an illustration from the MFP 3, the illustration data of the selected illustration to the MFP 3. The MFP 3 accepts, upon acquiring the illustration data of the selected illustration from the server 2, selection of a special medium as a medium on which the acquired illustration is to be printed. For example, the server 2 displays, on the display device 41, and accepts a selection of a special medium as media on which an illustration is to be printed. The MFP 3 prints, when a special medium is selected by the operation device 42, the illustration on the selected special medium.

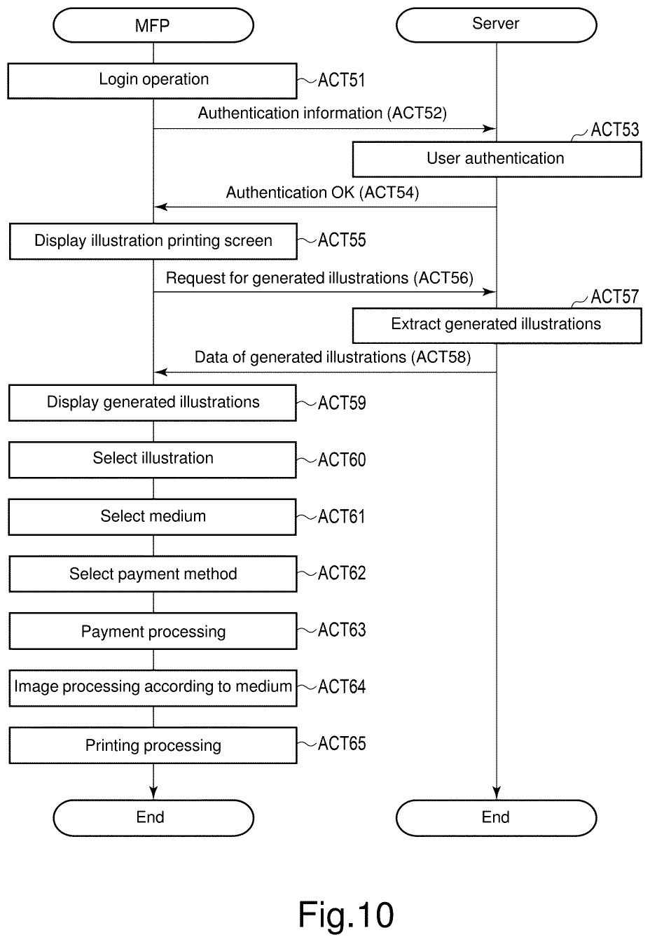

Next, a flow of illustration printing processing of printing the illustration generated by the server 2 in the image forming system 1 according to the embodiment on a special medium by the MFP 3 will be described. FIG. 10 is a sequence for describing the illustration printing processing of printing the illustration generated by the server 2 in the image forming system 1 according to the embodiment on a special medium by the MFP 3. The user selects illustration printing for printing an illustration stored in the server 2 on a special medium on the operation panel 40 of the MFP 3. When the illustration printing is selected, the system controller (controller) 50 of the MFP 3 is connected to the server 2 via the communication interface 56.

The system controller 50 of the MFP 3 accepts, upon being connected to the server 2, input of user information (authentication information) by the user as a login operation to the illustration providing service (ACT51). The system controller 50 of the MFP 3 transmits, to the server 2, user information including the authentication information input by the user together with the login request to the illustration providing service (ACT52).

The server 2 receives the login request to the illustration providing service from the MFP 3 by the communication interface 13. The processor 11 of the server 2 executes user authentication using the user information that includes authentication information received together with the login request (ACT53). When the user authentication succeeds, the processor 11 of the server 2 makes the user in a logged-in state and transmits notification indicating authentication successful (authentication OK) to the MFP 3.

The system controller 50 of the MFP 3 displays, upon receiving the authentication successful, an illustration printing screen that notifies being logged in and that illustration printing is possible on the display device 41 (ACT55). For example, the user instructs, when the illustration printing screen is displayed, to start printing an illustration that has been generated and stored in the server 2 using the operation device 42. The processor 51 of the MFP 3 requests, in accordance with a request from the user, the server 2 for illustrations that have been generated in accordance with a request from the logged-in user (ACT56).

The server 2 receives an illustration request that requests for the illustrations that have been generated from the MFP 3 by the communication interface 13. The processor 11 of the server 2 extracts, upon receiving the illustration request, illustrations generated in accordance with a request from the logged-in user from the storage device 14 (ACT57). For example, the processor 11 searches the storage device 14 for illustrations that have been stored in association with the logged-in user. The processor 11 transmits, to the MFP 3, the illustrations extracted from the storage device 14, which have been generated and stored in association with the logged-in user (illustrations generated in accordance with a request from the user) (ACT58).

The system controller 50 of the MFP 3 receives the illustrations (group of illustrations) transmitted from the server 2, which have been generated for the user, by the communication interface 56. The processor 51 of the system controller 50 of the MFP 3 displays, on the display device 41, the illustrations that have been generated and received from the server 2 (ACT59). The system controller 50 accepts an instruction to select an illustration to be printed while displaying the illustrations that have been generated and acquired from the server 2 on the display device 41 (ACT60). For example, the processor 51 displays a list of a plurality of illustrations (group of illustrations) received from the server 2 on the display device 41 and accepts selection of an illustration to be printed on the operation device 42.

The system controller 50 of the MFP 3 accepts, when an illustration to be printed is selected, selection of a special medium as a medium on which the selected illustration is to be printed (ACT61). For example, the processor 51 displays, on the display device 41, a list of special media (selection screen of special media) as media on which an illustration can be printed and accepts selection of a special medium on the operation device 42.

In the case where an illustration and a special medium are selected or an instruction to start printing is made, the system controller 50 of the MFP 3 performs processing of payment of printing of the illustration on the special medium (ACTs 62 and 63). For example, in the case where an illustration to be printed and a special medium have been decided, the processor 51 calculates the charge for printing. The processor 51 accepts, upon calculating the charger for printing, selection of a payment method as processing of payment (ACT62). The processor 51 performs, when a payment method is selected, processing of payment for the charge by the selected payment method (ACT63). However, for operational purposes, in the case where the processing of payment for the charge for each printing process is not performed, the processing of ACTs 62 and 63 may be omitted.

The system controller 50 of the MFP 3 performs, when the payment for the charge is completed (print execution is decided), image processing on the illustration to be printed in accordance with the selected special medium (ACT64). For example, the processor 51 performs image processing of correcting the image as the illustration to be printed by the image processing device 54 in accordance with the properties of the special medium and the like. As a specific example, the image processing device 54 may correct the illustration or the background color of the illustration in accordance with the color of the special medium. In addition, the image processing device 54 may correct the density, brightness, sharpness, and the like of the illustration to be printed in accordance with the material of the special medium.

The system controller 50 of the MFP 3 prints, upon performing image processing on the illustration in accordance with the special medium, the illustration on which the image processing has been performed on the special medium using the printer 20 (ACT65). For example, the printer 20 feeds the selected special medium and forms the image as the illustration after the image processing supplied from the system controller 50 on the supplied special medium.

As described above, the image forming system according to the embodiment includes a server that generates an illustration in accordance with a user's request and an MFP that prints the illustration generated by the server on a medium. As a result, according to the image forming system, it is possible to print an illustration generated in accordance with a user's request on a special media.

In the image forming system according to the embodiment, the server is capable of generating an illustration according to a user's request using an illustration generation model of an illustrator selected by a user. As a result, the user can receive, by selecting an illustrator, a service for printing an illustration generated in the style of the selected illustrator on a medium such as a special medium.

In the image forming system according to the embodiment, the server acquires a group of illustrations for learning provided from an illustrator who has given consent to provide illustrations, and creates or updates an illustration generation model for each illustrator by machine learning using the group of illustrations for learning provided from the illustrator. As a result, the image forming system is capable of forming an illustration generation model from which an illustration that reflects the personality of the illustration can be generated using the group of illustrations for learning provided from the illustrator.

In the image forming system according to the embodiment, the server stores the illustration generated in accordance with a user's request. The MFP acquires, when the user has successfully logged in the server, the illustration generated in accordance with a user's request from the server. The MFP prints the illustration acquired from the server on a special medium selected by the user. As a result, the MFP is capable of acquiring the illustration that has been generated in accordance with a user's request from the server and printing the illustration acquired from the server on the special medium selected by the user.

Further, in the image forming system according to the embodiment, the MFP prints an illustration on which image processing has been performed in accordance with the special medium selected by the user on the special medium. As a result, the MFP is capable of providing, to the user, a print of the illustration that has been generated in accordance with a user's request, on which image processing has been performed in accordance with the special medium selected by the user.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image forming system, comprising:
a server that includes
a first communication interface that performs communication via a network, and
a processor configured to generate an illustration using an illustration generation condition specified by a user in a device that performs communication via the network by the first communication interface; and
an image forming apparatus that includes
a second communication interface that communicates with the server,
a controller configured to acquire the illustration generated by the second communication interface using the illustration generation condition from the server, and
a printer that prints the illustration acquired from the server on a medium.

2. The image forming system according to claim 1, wherein
the server further includes a memory that stores an illustration generation model for each illustrator.

3. The image forming system according to claim 2, wherein
the processor of the server is further configured to generate an illustration using the illustration generation condition specified by the user and an illustration generation model of an illustrator specified by the user.

4. The image forming system according to claim 1, wherein
the processor of the server performs machine learning using a group of illustrations for each illustrator.

5. The image f system according to claim 4, wherein
the server includes a memory that stores an illustration generation model for each illustrator, and
the processor of the server is further configured to create the illustration generation model for each illustrator by the machine learning.

6. The image forming system according to claim 1, wherein
the server further includes a memory that stores user information, and
the processor of the server is further configured to generate an illustration using an illustration generation condition specified by a user authenticated using the user information stored in the memory.

7. The image forming system according to claim 6, wherein
the server further includes a storage device that stores an illustration, and
the processor of the server is further configured to store, in the storage device, the illustration generated using the illustration generation condition specified by the authenticated user.

8. The image forming system according to claim 6, wherein
the image forming apparatus further includes an input device that inputs a user's operation, and
the controller of the image forming apparatus is further configured to acquire, where a user who operates the input device is authenticated by the server, the illustration generated using the illustration generation condition specified by the authenticated user from the server.

9. The image forming system according to claim 8, wherein
the controller of the image forming apparatus causes the printer to print the illustration acquired from the server on the medium selected by an operation input via the input device.

10. The image forming system according to claim 9, wherein
the controller of the image forming apparatus is further configured to perform image processing on the illustration in accordance with a medium selected by the input device.
